(19) United States
(12) Patent Application Publication
(10) Pub. No.: US 2026/0077560 A1
(43) Pub. Date: Mar. 19, 2026

(54) HOLLOW FILL ADDITIVE MANUFACTURING

(71) Applicant: International Business Machines Corporation, Armonk, NY (US)

(72) Inventors: Martin G. Keen, Cary, NC (US); Sarbajit Kumar Rakshit, Kolkata (IN); Carolina Garcia Delgado, Zapopan (MX); Tushar Agrawal, West Fargo, ND (US)

(21) Appl. No.: 18/885,809

(22) Filed: Sep. 16, 2024

(51) Int. Cl. B29C 64/393; B29C 64/153; B29C 64/336; B33Y 10/00; B33Y 40/00; B33Y 50/02

(52) U.S. Cl. CPC B29C 64/393; B29C 64/153; B29C 64/336; B33Y 10/00; B33Y 40/00; B33Y 50/02

(57) ABSTRACT

A method for hollow fill additive manufacturing includes identifying a solidification pattern for an object with a first hollow portion being created by a primary nozzle on an additive manufacturing device during a hollow fill additive manufacturing process. The method further includes generating an additive manufacturing fill plan for the first hollow portion of the object based at least on the solidification pattern. The method further includes determining to dispense a first type of particles into the first hollow portion of the object based on the additive manufacturing fill plan. The method further includes dispensing, via a secondary nozzle, the first type of particles into the first hollow portion of the object.

### BACKGROUND

This disclosure relates generally to additive manufacturing, and in particular to filling hollow portions of an object created through additive manufacturing.

Additive manufacturing typically utilizes a three-dimensional digital file as a blueprint to print an object by depositing one layer at a time until the object is formed based on the three-dimensional digital file. The additive process includes adding layer upon layer of material in a successive manner and each layer represents a cross-sectional slice of the object being constructed. Additive manufacturing allows for complex shapes to be constructed by reducing an amount of milling or cutting required to obtain a final form of the object being constructed. Objects constructed through additive manufacturing are primarily hollow to reduce printing times and to reduce material waste, if the additional material does not affect a structural integrity of the object.

### SUMMARY

Embodiments in accordance with the present invention disclose a method, computer program product and computer system for hollow fill additive manufacturing, the method, computer program product and computer system can identify a solidification pattern for an object with a first hollow portion being created by a primary nozzle on an additive manufacturing device during a hollow fill additive manufacturing process. The method, computer program product and computer system can generate an additive manufacturing fill plan for the first hollow portion of the object based at least on the solidification pattern. The method, computer program product and computer system can determine to dispense a first type of particles into the first hollow portion of the object based on the additive manufacturing fill plan. The method, computer program product and computer system can dispense, via a secondary nozzle, the first type of particles into the first hollow portion of the object.

### BRIEF DESCRIPTION OF THE SEVERAL VIEWS OF THE DRAWINGS

FIG. 1 is a functional block diagram illustrating a computing environment, in accordance with an embodiment of the present invention.

FIG. 2 depicts a flowchart of a hollow fill additive manufacturing program for filling hollow portions of an object during an additive manufacturing process, in accordance with an embodiment of the present invention.

FIG. 3 depicts a hollow fill additive manufacturing program operating on an additive manufacturing device with an integrated particular dispersion device for filling hollow portions of an object during an additive manufacturing process, in accordance with an embodiment of the present invention.

FIG. 4 depicts a hollow fill additive manufacturing program operating on an additive manufacturing device connected to a particular dispersion device for filling hollow portions of an object during an additive manufacturing process, in accordance with an embodiment of the present invention.

FIG. 5 depicts an illustrative example of an object being constructed utilizing a hollow fill additive manufacturing program for filling hollow portions of an object during an additive manufacturing process, in accordance with an embodiment of the present invention.

FIG. 6A depicts an illustrative example of a layer of the object from FIG. 5 being constructed utilizing an additive manufacturing device, in accordance with an embodiment of the present invention.

FIG. 6B depicts an illustrative example of multiple layers of the object from FIG. 5 being constructed utilizing an additive manufacturing device, in accordance with an embodiment of the present invention.

FIG. 6C depicts an illustrative example of the object from FIG. 5 being constructed utilizing an additive manufacturing device and a particular dispersion device to fill hollow portions of the object, in accordance with an embodiment of the present invention.

FIG. 6D depicts an illustrative example of a final layer of the object from FIG. 5 being constructed utilizing an additive manufacturing device, in accordance with an embodiment of the present invention.

FIG. 6E depicts an illustrative example of a transparent sideview of the object from FIG. 5 constructed utilizing an additive manufacturing device and a particle dispersion device, in accordance with an embodiment of the present invention.

### DETAILED DESCRIPTION

Embodiments of the present invention provide an additive manufacturing process that includes filling hollow portions of an object utilizing various particles and material. Embodiments of the present invention can identify solidification pattern of the object with hollow portions being created (i.e., printed) during the additive manufacturing process, where the identification is facilitated by one or more scanning modules. Embodiments of the present invention can calculate a volume of particles required to fill each hollow portion of the object based on the solidification pattern and can analyze operational and environment parameters applicable to the additive manufacturing process to identify one or more types of particles to fill each hollow portion of the object. Embodiments of the present can determine a ratio of the one or more types of particles to fill each hollow portion of the object and generate an additive manufacturing fill plan for the hollow portions to regulate a rate of particles dispensing through a secondary nozzle located on particle dispersion device, where a primary nozzle for dispensing additive material is located on an additive manufacturing device. Embodiments of the present invention can monitor the additive manufacturing process of the object and based on the additive manufacturing fill plan dispense the one or more types of particles in each hollow portion of the object during the printing process. During the dispensing of the one or more types of particles, embodiments of the present invention can monitor and adjust the rate of particles dispensing to prevent a formation of deposit layers on the object still being printed by the primary nozzle.

Filling hollow portions of the object during the additive manufacturing process provides enhanced vibration dampening of the object. By placing particles and/or material within hollow portions of the objects, the particles and/or material can move and shift within the hollow object in response to vibrations, thereby dissipating kinetic energy and reducing the amplitude of oscillations. Filling hollow portions of the object during the additive manufacturing process also provides vibration isolation of the object, where determining one or more types of particles and a ratio for the one or more types of particles allows for the object to be isolated from external vibrations, ensuring the vibration do not propagate throughout the structure of the object. Filling hollow portions of the object during the additive manufacturing process also provides enhanced structural integrity of the object by reinforcing the structure with the one or more types of particles and/or material, resulting in an object that is more resistant to deformation or damage. Filling hollow portions of the object during the additive manufacturing process also provides managed weight distribution of the object, where the particles filling the hollow portions of the object can optimize weight distribution of the object based on a required application to prevent instability.

Filling hollow portions of the object during the additive manufacturing process also provides control over tuning of the resonance frequency. For example, a type and a distribution of the particles and/or material through the object based on the additive manufacturing fill plan can allow for a tuning of the object's resonance frequency, which is typically required in large physical structures and aerospace components. Filling hollow portions of the object during the additive manufacturing process also provides energy absorption benefits for absorbing and dissipating energy from external forces (e.g., impact) that the object can experience. Filling hollow portions of the object during the additive manufacturing process also provides thermal insulation to reduce heat transfer via the hollow portions of the object. Filling hollow portions of the object during the additive manufacturing process also provides sound absorption when particles and/or material with sound absorbing properties are placed within the hollow portions of the object. Filling hollow portions of the object during the additive manufacturing process also provides resistance to cracking when particles and/or material (e.g., resin) are deposited into the hollow portions of the object.

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments. It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

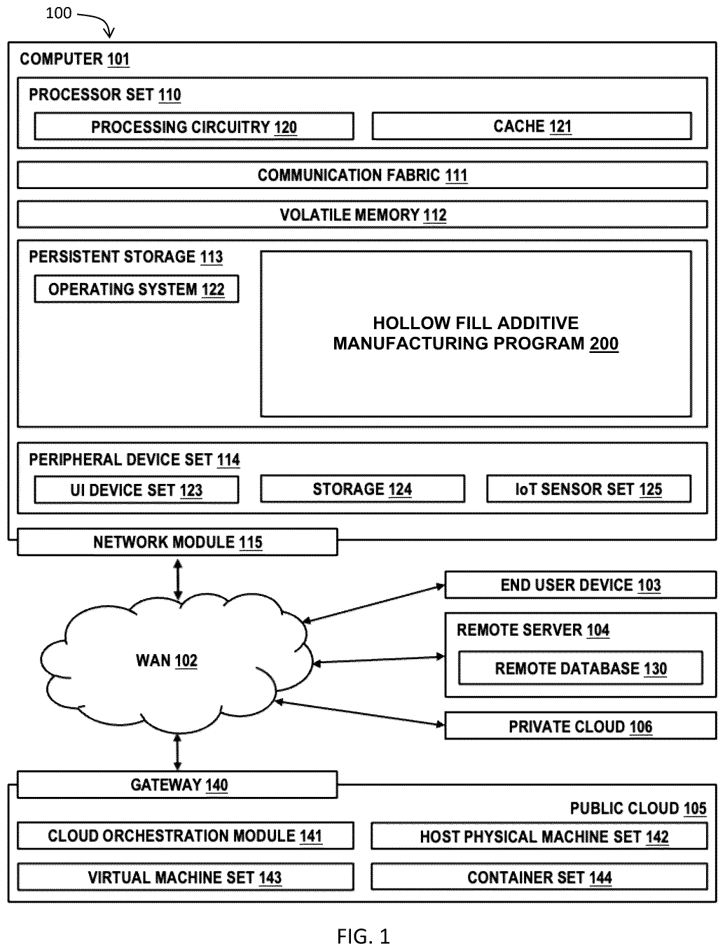

FIG. 1 is a functional block diagram illustrating a computing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 contains an example of an environment for the execution of at least some of the computer code involved in performing the inventive methods, such as hollow fill additive manufacturing program 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

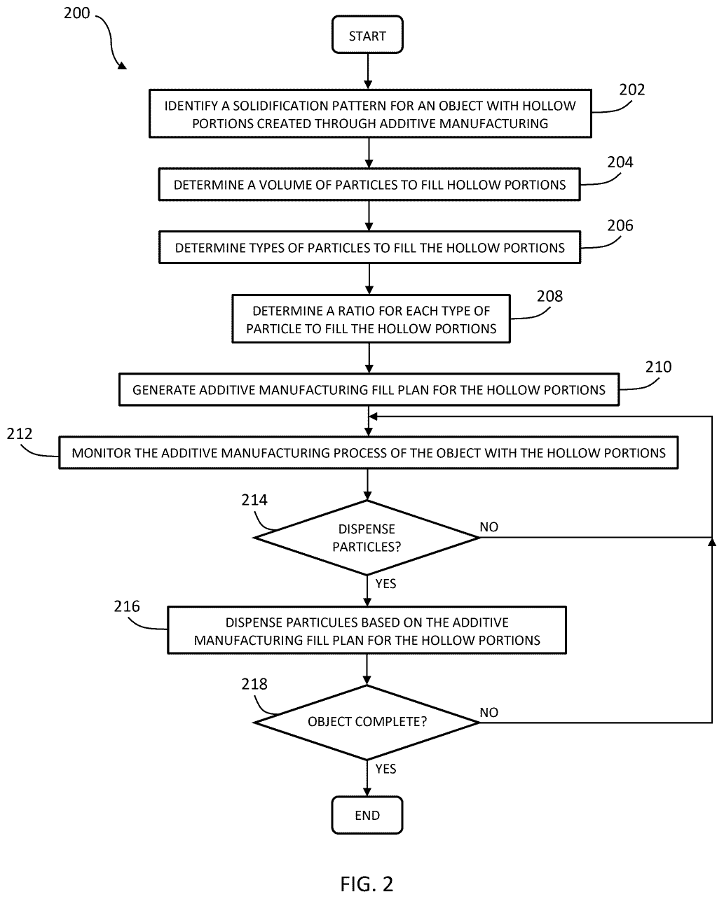

FIG. 2 depicts a flowchart of a hollow fill additive manufacturing program for filling hollow portions of an object during an additive manufacturing process, in accordance with an embodiment of the present invention.

Hollow fill additive manufacturing program 200 identifies a solidification pattern for an object with hollow portions created through additive manufacturing (202). A solidification pattern represents a calculated rate at which layers of material being deposited to form the object by an additive manufacturing device solidifies, thus allowing for particles to contact each layer of material without becoming embedded in the layer of material. In one embodiment, hollow fill additive manufacturing program 200 utilizes one or more scanning modules (e.g., thermal imager, infrared thermometer) coupled to the additive manufacturing device to provide thermal values for a surface of the layer of material of an object being deposited. Based on the thermal values, hollow fill additive manufacturing program 200 calculates a rate of solidification relative to a volume for each hollow portion being formed as the object is being printed. Based on the rate of solidification and a three-dimensional model file for the object with the hollow portions being printed, hollow fill additive manufacturing program 200 identifies a solidification pattern for the object.

In one example, an additive manufacturing device is being utilized to create a structure that is a building, where the walls of the building include hollow portions to reduce additive material waste and to reduce crack propagation. As the structure is being created by the additive manufacturing device, hollow fill additive manufacturing program 200 receives thermal values from the one or more scanning modules coupled to the additive manufacturing device. Based on the thermal values for each layer being deposited, hollow fill additive manufacturing program 200 determines that a rate of solidification for the solidification pattern is 12 inches of height for every 10 minutes. With the determined rate of solidification, hollow fill additive manufacturing program 200 can utilize a three-dimensional model file for the structure to determine a rate of dispensing particles based on a calculated volume of the hollow portions that can be filled.

In some embodiments, prior to identifying the solidification pattern for the object with hollow portions created through additive manufacturing, hollow fill additive manufacturing program 200 receives the three-dimensional model file for the object with the hollow portions.

The three-dimensional model file is a mathematical coordinate-based representation for an internal and/or external surface of an object in three-dimensions defined along the x-axis, y-axis, and z-axis. The three-dimensional digital model can be created utilizing a computer-aided design (CAD) package, a three-dimension scanner of an existing object, and/or multiple digital images utilizing photogrammetry to extract three-dimensional measurements from two-dimensional data (i.e., the multiple digital images). In one embodiment, hollow fill additive manufacturing program 200 can receive a three-dimensional digital model file for hollow fill additive manufacturing in the form of a stereolithography file format (STL) file or additive manufacturing file format (AMF) file, for a CAD model of the object. In another embodiment, hollow fill additive manufacturing program 200 can receive a three-dimensional model file for hollow fill additive manufacturing in the form of a three-dimensional scan of an existing objecting utilizing a hand-held laser scanner, a structure-light three-dimensional scanner, or a modulated light three-dimensional scanner. In yet another embodiment, hollow fill additive manufacturing program 200 can receive a three-dimensional model file for hollow fill additive manufacturing in the form of a three-dimensional model file generated by photogrammetry software for a scanned object, where the photogrammetric software can provide a necessary CAD model for the scanned object with the hollow portions in the form of an STL file or AMF file.

Hollow fill additive manufacturing program 200 determines a volume of particles to fill hollow portions (204). To optimize the hollow fill additive manufacturing process, hollow fill additive manufacturing program 200 actively fills, via the particle dispersion device, each hollow portion of the object as the layers of the object solidify according to the solidification pattern, while the additive manufacturing device continues to deposit layers creating the object. Hollow fill additive manufacturing program 200 allows for a continuous manufacturing process that reduces idle time of either the particle dispersion device or the additive manufacturing device.

Utilizing the three-dimensional model file for the object with the hollow portions, hollow fill additive manufacturing program 200 determines a total volume of particles to fill each hollow portion of the object during the hollow fill manufacturing process. Since the object includes hollow portions that might not be accessible once the object is fully created, hollow fill additive manufacturing program 200 utilizes the solidification pattern to fill each hollow portion of the object as the object is being created by the additive manufacturing device. As previously discussed, the solidification pattern utilizes the rate of solidification for each deposited layer of material forming the object and the three-dimensional model file for the object with the hollow portions, therefore hollow fill additive manufacturing program 200 determines the total volume of particles to fill each hollow portion of the object and a rate of fill for the total volume of particles to fill each hollow portion of the object.

Hollow fill additive manufacturing program 200 determines the types of particles to fill the hollow portions (206). In this embodiment, hollow fill additive manufacturing program 200 utilizes the three-dimensional digital model file to determine the types of particles to fill each hollow portion of the object. The three-dimensional digital model file can indicate one or more types of particles to fill each hollow portion of the object. In an alternative embodiment, hollow fill additive manufacturing program 200 utilizes the three-dimensional digital model file of the object to identify the hollow portions of the object and queries a user to provide a selection of one or more types of particles to fill each hollow portion of the object. Based on the particle dispersion device, hollow fill additive manufacturing program 200 can deposit the one or more types of particles and/or material concurrently or in succession based on any structural requirements for the object. In an example, hollow fill additive manufacturing program 200 determines that two types of particles are to fill a hollow portion of the object, where a first type of particle provides additional structure to the object and a second type of particle provides thermal insulation to the object.

Hollow fill additive manufacturing program 200 determines a ratio for each type of particle to fill the hollow portions (208). In this embodiment, hollow fill additive manufacturing program 200 utilizes the three-dimensional digital model file to determine a ratio for the different types of particles to fill each hollow portion of the object. The three-dimensional digital model file can indicate a ratio for the one or more types of particles to fill each hollow portion of the object. In an alternative embodiment, hollow fill additive manufacturing program 200 queries a user to provide a ratio for the one or more types of particles to fill each hollow portion of the object. Based on the particle dispersion device, hollow fill additive manufacturing program 200 can deposit the one or more types of particles and/or material concurrently or in succession according to the determines ratio for each type of particle to fill the hollow portions of the object. In an example, hollow fill additive manufacturing program 200 determines that two types of particles are to fill a hollow portion of the object, where a first type of particle is deposited first to fill 20% of a volume of the hollow portion of the object and a second type of particle is deposited second to fill a remaining 80% of the volume of the hollow portion of the object.

Hollow fill additive manufacturing program 200 generates an additive manufacturing fill plan for the hollow portions (210). The additive manufacturing fill plan represents the hollow fill additive manufacturing process for the hollow portions of the object that hollow fill additive manufacturing program 200 monitors and dispenses particles utilizes the particle dispersion device. In this embodiment, hollow fill additive manufacturing program 200 generates the additive manufacturing fill plan based on the solidification pattern, the types of particles to fill each of the hollow portions of the object, and the ratio for each type of particle to fill each of the hollow portions of the object. Hollow fill additive manufacturing program 200 utilizes the additive manufacturing fill plan as the basis for determining when to dispense, via the particle dispersion device, particles into each hollow portion of the object as the additive manufacturing device creates the object.

Hollow fill additive manufacturing program 200 monitors the additive manufacturing process of the object with the hollow portions (212). As previously discussed, hollow fill additive manufacturing program 200 can receive, from one or more scanning modules coupled to the additive manufacturing device, thermal values for a surface of the layer of material of an object being deposited. In this embodiment, hollow fill additive manufacturing program 200 monitors the additive manufacturing process of the object with the hollow portions by receiving thermal values for the surface of the layers of material being deposited and determining whether the thermal values match the solidification pattern found in the additive manufacturing fill plan. In another embodiment, hollow fill additive manufacturing program 200 monitors the additive manufacturing process of the object with the hollow portions based on a progress information received by the additive manufacturing device creating the object with the hollow portions. For example, hollow fill additive manufacturing program 200 can receive the progress information as a percentage value (e.g., 35%) indicating a portion of the object that has already been printed by the additive manufacturing device.

Hollow fill additive manufacturing program 200 determines whether to dispense the particles into the hollow portions of the objects (decision 214). In the embodiment where hollow fill additive manufacturing program 200 monitors the additive manufacturing process of the object with the hollow portions by receiving thermal values for the surface of the layers of material being deposited, hollow fill additive manufacturing program 200 determines whether to dispense the particles into the hollow portions of the objects based on the thermal values matching values found in the solidification pattern found in the additive manufacturing fill plan. In the embodiment where hollow fill additive manufacturing program 200 monitors the additive manufacturing process of the object with the hollow portions based on a progress information received by the additive manufacturing device, hollow fill additive manufacturing program 200 determines whether to dispense the particles into the hollow portions of the objects based on a completion threshold being reached. For example, as hollow fill additive manufacturing program 200 receives the progress information, hollow fill additive manufacturing program 200 determines to dispense the particles upon the percentage value indicating the portion of the object that has already been printed by the additive manufacturing device reaching the completion threshold (e.g., 45%).

In the event hollow fill additive manufacturing program 200 determines to dispense the particles into the hollow portions of the object (“yes” branch, decision 214), hollow fill additive manufacturing program 200 dispenses particles based on the additive manufacturing fill plan for the hollow portions (216). In the event hollow fill additive manufacturing program 200 determines not to dispense the particles into the hollow portions of the object (“no” branch, decision 214), hollow fill additive manufacturing program 200 reverts to monitoring the additive manufacturing process of the object with the hollow portions (212).

Hollow fill additive manufacturing program 200 dispenses particles based on the additive manufacturing fill plan for the hollow portions (216). Hollow fill additive manufacturing program 200 dispenses particles based on the additive manufacturing fill plan for each hollow portion by instructing the particle dispersion device to release one or more types of particles at a given location. In one embodiment, particle dispersion device is integrated into additive manufacturing device, where hollow fill additive manufacturing program 200 utilizes a known position of the object being created by the additive manufacturing device to instruct the particle dispersion device to dispense (i.e., deposit) one or more types of particles at the give location defined by x, y, and z coordinate. A primary nozzle of the additive manufacturing device can be positioned near a secondary nozzle of the particle dispersion device and hollow fill additive manufacturing program 200 instructs the particle dispersion device to dispense particles based on additive manufacturing fill plan for the follow portions of the object. Hollow fill additive manufacturing program 200 can synchronize the primary nozzle and the secondary nozzle to ensure the additive manufacturing device and the particle dispersion device do not interfere with one another.

In another embodiment, particle dispersion device is separate from the additive manufacturing device and hollow fill additive manufacturing program 200 instructs a secondary nozzle of the particle dispersion device to relocate to the given location based on x, y, and z coordinates. Hollow fill additive manufacturing program 200 instructs the particle dispersion device to relocate such that the secondary nozzle is positioned over a hollow portion of the object that is to be filled with one or more types of particles. Hollow fill additive manufacturing program 200 receives confirmation from the particle dispersion device that the secondary nozzle is in position and instructs the particle dispersion device to dispense particles based on additive manufacturing fill plan for the follow portions of the object.

A number of particles that hollow fill additive manufacturing program 200 dispense is defined by the additive manufacturing fill plan. In one embodiment, hollow fill additive manufacturing program 200 dispenses the particles in predetermined volumes and in set intervals according to the additive manufacturing fill plan. In another embodiment, hollow fill additive manufacturing program 200 dispenses the particles in a continuous manner, where hollow fill additive manufacturing program 200 instructs the secondary nozzle to relocate to multiple given locations as the particles are dispensed.

Hollow fill additive manufacturing program 200 determines whether the manufacturing of the object with the hollow filled portions is complete (decision 218). In the event hollow fill additive manufacturing program 200 determines the manufacturing of the object with the hollow filled portions is not complete (“no” branch, decision 218), hollow fill additive manufacturing program 200 reverts to monitoring the additive manufacturing process of the object with the hollow portions (212). In the event hollow fill additive manufacturing program 200 determines the manufacturing of the object with the hollow filled portions is complete (“no” branch, decision 218), hollow fill additive manufacturing program 200 ceases operations.

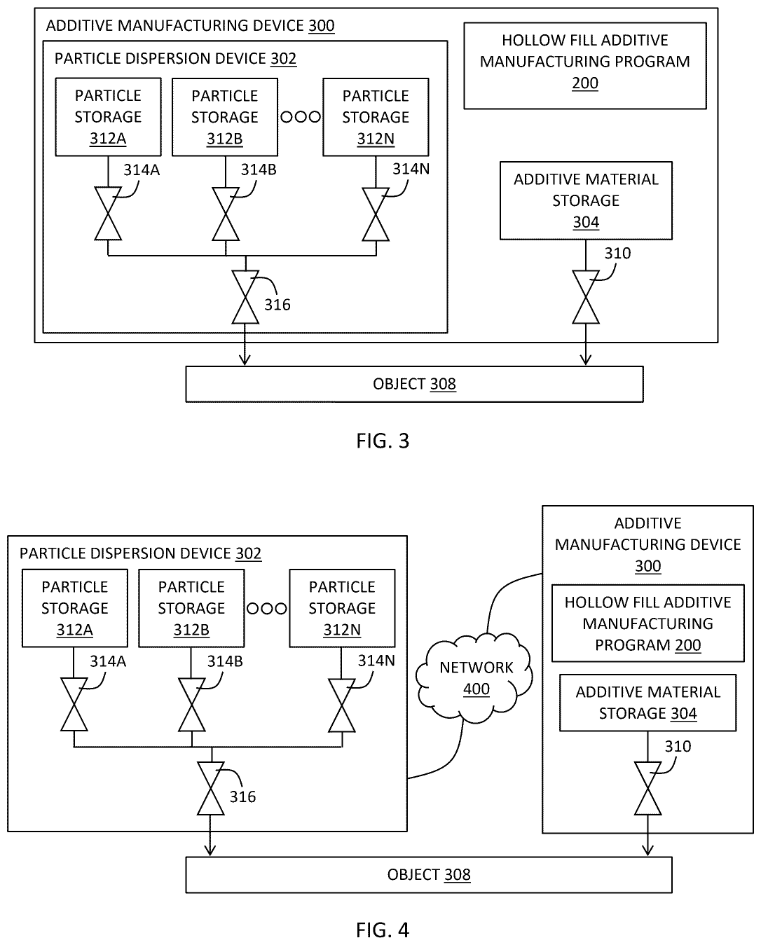

FIG. 3 depicts a hollow fill additive manufacturing program operating on an additive manufacturing device with an integrated particular dispersion device for filling hollow portions of an object during an additive manufacturing process, in accordance with an embodiment of the present invention. In this embodiment, hollow fill additive manufacturing program 200 operates on additive manufacturing device 300, where particle dispersion device 302 is integrated into additive manufacturing device 300. Additive manufacturing device 300 includes additive material storage 304 for storing the filament utilized for creating each layer of object 308 with hollow portions during a hollow fill additive manufacturing process. Additive material storage 304 is mechanically coupled to additive material control valve 310, where in some embodiments hollow fill additive manufacturing program 200 activates additive material control valve 310 to release the filament through a primary nozzle during the hollow fill additive manufacturing process.

Particle dispersion device 302 includes particle storage 312A, 312B, and 312N associated with a particle type, where particle storage 312N represents an N^{th} particle type (e.g., 12^{th}) that is being stored in particle dispersion device 302. Each of particle storage 312A, 312B, and 312N is mechanically coupled to a respective control value 314A, 314B, and 314N, where in some embodiments hollow fill additive manufacturing program 200 actives each control valve 314A, 314B, and 314N to release a specific particle type in particle storage 312A, 312B, and 312N. In other embodiments, hollow fill additive manufacturing program 200 instructs particle dispersion device 302 to activate one or more control valves 314A, 314B, and 314N to release the specific particle type in particle storage 312A, 312B, and 312N. Each of control valves 314A, 314B, and 314N are mechanically coupled to particle control valve 316. Similar to control valves 314A, 314B, and 314N, hollow fill additive manufacturing program 200 can activate or instruct particle dispersion device 302 to activate particle control valve 316. Particle control valve 316 controls particle flow through a secondary nozzle during the hollow fill additive manufacturing process to dispense particles into one or more hollow portions of object 308 being printed by the primary nozzle of additive manufacturing device 300.

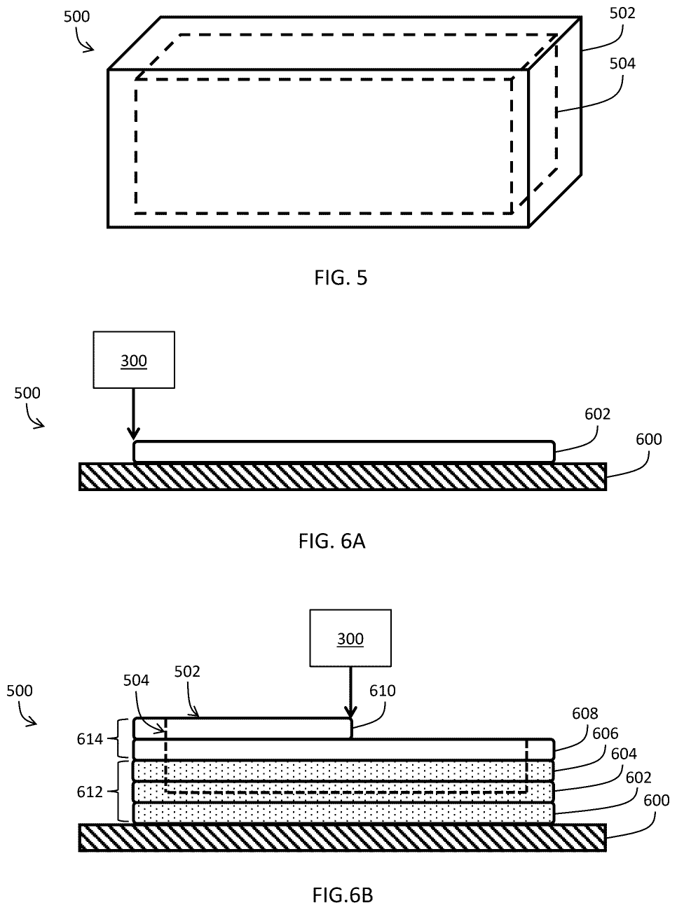

FIG. 4 depicts a hollow fill additive manufacturing program operating on an additive manufacturing device connected to a particular dispersion device for filling hollow portions of an object during an additive manufacturing process, in accordance with an embodiment of the present invention. In this embodiment, hollow fill additive manufacturing program 200 operates on additive manufacturing device 300, where particle dispersion device 302 is connected to additive manufacturing device 300 via network 400. Network 400 represents any communication network that allows for data transfer between additive manufacturing device 300 and particle dispersion device 302. Additive manufacturing device 300 includes additive material storage 304 for storing the filament utilized for creating each layer of object 308 with hollow portions during a hollow fill additive manufacturing process. Additive material storage 304 is mechanically coupled to additive material control valve 310, where in some embodiments hollow fill additive manufacturing program 200 activates additive material control valve 310 to release the filament through a primary nozzle during the hollow fill additive manufacturing process.

Particle dispersion device 302 includes particle storage 312A, 312B, and 312N associated with a particle type, where particle storage 312N represents an N^{th} particle type (e.g., 12^{th}) that is being stored in particle dispersion device 302. Each of particle storage 312A, 312B, and 312N is mechanically coupled to a respective control value 314A, 314B, and 314N, where in some embodiments hollow fill additive manufacturing program 200 actives, via network 400, each control valve 314A, 314B, and 314N to release a specific particle type in particle storage 312A, 312B, and 312N. In other embodiments, hollow fill additive manufacturing program 200 instructs, via network 400, particle dispersion device 302 to activate one or more control valves 314A, 314B, and 314N to release the specific particle type in particle storage 312A, 312B, and 312N. Each of control valves 314A, 314B, and 314N are mechanically coupled to particle control valve 316. Similar to control valves 314A, 314B, and 314N, hollow fill additive manufacturing program 200 can activate or instruct particle dispersion device 302 to activate, via network 400, particle control valve 316. Particle control valve 316 controls particle flow through a secondary nozzle during the hollow fill additive manufacturing process to dispense particles into one or more hollow portions of object 308 being printed by the primary nozzle of additive manufacturing device 300.

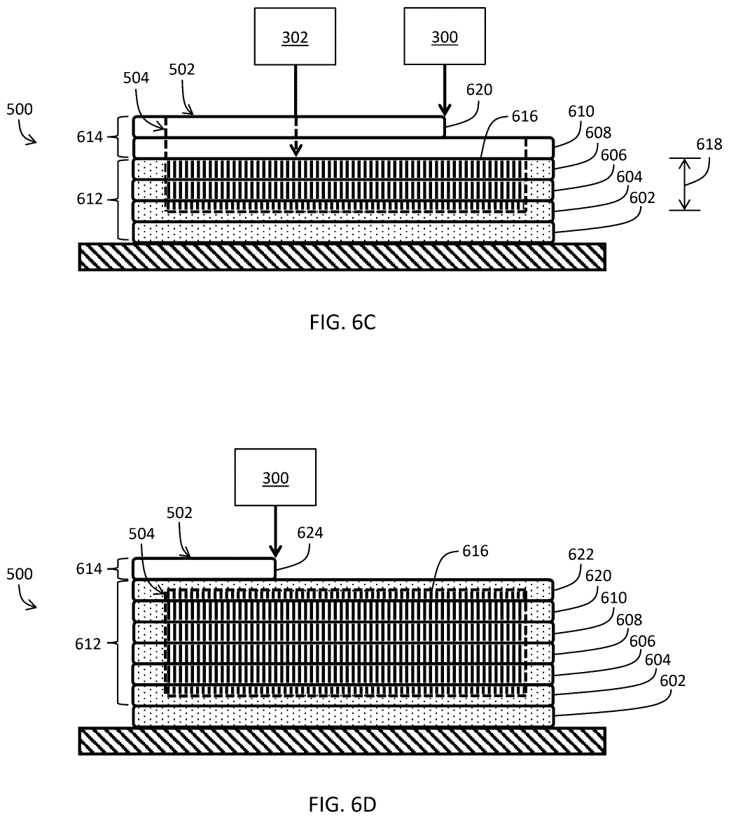

FIG. 5 depicts an illustrative example of an object being constructed utilizing a hollow fill additive manufacturing program for filling hollow portions of an object during an additive manufacturing process, in accordance with an embodiment of the present invention. In this embodiment, object 500 is being created during a hollow fill additive manufacturing process, where object 500 includes solid portion 502 and hollow portion 504.

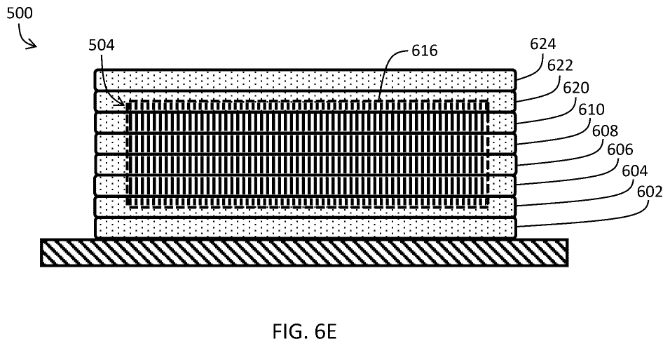

FIG. 6A depicts an illustrative example of a layer of the object from FIG. 5 being constructed utilizing an additive manufacturing device, in accordance with an embodiment of the present invention. In this embodiment, hollow fill additive manufacturing program 200 initializes a hollow fill additive manufacturing process to create object 500 from FIG. 5. As additive manufacturing device 300 deposits first layer 602 onto platform 600, hollow fill additive manufacturing program 200 identifies a solidification pattern for object 500 being created by additive manufacturing device 300. As previously discussed, based on a rate of solidification and a three-dimensional model file for object 500 being created by additive manufacturing device 300, hollow fill additive manufacturing program 200 identifies the solidification pattern for the object. Hollow fill additive manufacturing program 200 determines a volume of particles to fill hollow portion 504, determines a type of particle to fill hollow portion 504, and determines a ratio for each type of particle to fill hollow portion 504. In this embodiment, hollow fill additive manufacturing program 200 determines to utilize a single type of particle to fill hollow portion 504, therefore hollow fill additive manufacturing program 200 determines a ratio of 1:1 is to be used to fill hollow portion 504 with the single type of particle. Hollow fill additive manufacturing program 200 generates the additive manufacturing fill plan for object 500 based on the solidification pattern, the type of particles to fill hollow portion 504, and the ratio for the particles to fill hollow portion 504.

FIG. 6B depicts an illustrative example of multiple layers of the object from FIG. 5 being constructed utilizing an additive manufacturing device, in accordance with an embodiment of the present invention. In this embodiment, additive manufacturing device 300 continues to create object 500 by depositing layer 604, 606, 608, and 610 on top of layer 602 deposited on platform 600 to form solid portion 502 of object 500. As additive manufacturing device 300 deposits layers 604, 606, 608, and 610, hollow portion 504 of object 500 is also created. Hollow fill additive manufacturing program 200 monitors the additive manufacturing process of object 500 and determines whether to dispense particles into hollow portion 504. In this embodiment, hollow fill additive manufacturing program 200 determines, utilizing scanning module on additive manufacturing device 300, first region 612 that includes layers 602, 604, and 606 has solidified. Additionally, hollow fill additive manufacturing program 200 determines, utilizing scanning module on additive manufacturing device 300, second region 614 that includes layers 608 and 610 has yet to solidify.

FIG. 6C depicts an illustrative example of the object from FIG. 5 being constructed utilizing an additive manufacturing device and a particular dispersion device to fill hollow portions of the object, in accordance with an embodiment of the present invention. In this embodiment, based on the additive manufacturing fill plan, hollow fill additive manufacturing program 200 determines to dispense particles into hollow portion 504 of object 500. Hollow fill additive manufacturing program 200 dispenses, via particle dispersion device 302, particles 616 into a partial volume of hollow portion 504 with height 618. Since hollow fill additive manufacturing program 200 monitors the additive manufacturing process of object 500, hollow fill additive manufacturing program 200 determines first region 612 now includes layers 602, 604, 606, and 608 that have solidified and second regions 614 include layers 610 and 620 that have yet to solidify. Therefore, hollow fill additive manufacturing program 200 dispenses particles 616 into hollow portion 504 up to height 618, until another layer (i.e., layer 610) of object 500 has solidified.

FIG. 6D depicts an illustrative example of a final layer of the object from FIG. 5 being constructed utilizing an additive manufacturing device, in accordance with an embodiment of the present invention. In this embodiment, hollow fill additive manufacturing program 200 has filled hollow portion 504 of object 500 with particles 616, but has yet to finish creating object 500. First region 612 now includes layers 602, 604, 606, 608, 610, 620, and 622 that have solidified and second region 614 now includes layer 624 that has yet to solidify. Additive manufacturing device 300 continues to deposit layer 624 to finish solid portion 502 of object 500.

FIG. 6E depicts an illustrative example of a transparent sideview of the object from FIG. 5 constructed utilizing an additive manufacturing device and a particle dispersion device, in accordance with an embodiment of the present invention. In this embodiment, hollow fill additive manufacturing program 200 has filled hollow portion 504 of object 500 with particles 616 has also finished creating object 500. First region 612 now includes layers 602, 604, 606, 608, 610, 620, 622, and 624 that have solidified to create object 500 with particles 616 filled in hollow portion 504.

In some embodiments, hollow fill additive manufacturing program 200 creates a knowledge corpus for various types of particles and applications. Embodiments of the present invention can utilize historical data for different types of granular materials, specification data, and physical properties, for filling hollow portions of objects to achieve specific performance metrics like vibration control, thermal control, and resonance control. The historical data can include the sensory data, investigation reports, and material properties test results. Embodiments of the present invention can utilize large language models to gather existing knowledge about granular materials and the respective applications in additive manufacturing and engineering contexts. Embodiments of the present invention can source product specifications, intended applications, and any testing data from manufacturer and/or supplier publicly available digital content.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
identifying a solidification pattern for an object with a first hollow portion being created by a primary nozzle on an additive manufacturing device during a hollow fill additive manufacturing process;
generating an additive manufacturing fill plan for the first hollow portion of the object based at least on the solidification pattern;
determining to dispense a first type of particles into the first hollow portion of the object based on the additive manufacturing fill plan; and
dispensing, via a secondary nozzle, the first type of particles into the first hollow portion of the object.

2. The computer-implemented method of claim 1, further comprising:
determining a volume of particles to at least partially fill the first hollow portion of the object;
determining the first type out of a plurality of types of particles to at least partially fill the first hollow portion of the object; and
determining a ratio for the first type of particles to at least partially fill the first hollow portion of the object.

3. The computer-implemented method of claim 2, wherein the additive manufacturing fill plan is further based on the first type of particles and the ratio for the first type of particles to at least partially fill the first hollow portion of the object.

4. The computer-implemented method of claim 2, further comprising:
determining a second type out of the plurality of types of particles to at least partially fill the first hollow portion of the object;
determining to dispense a second type of particles into the first hollow portion of the object based on the additive manufacturing fill plan; and
dispensing, via the secondary nozzle, the second type of particles into the first hollow portion of the object.

5. The computer-implemented method of claim 4, wherein the additive manufacturing fill plan is further based on the first type of particles, the second type of particles, and the ratio for the first type of particles to at least partially fill the first hollow portion of the object.

6. The computer-implemented method of claim 1, further comprising:
monitoring, via one or more scanning modules, the hollow fill additive manufacturing process, wherein monitoring includes receiving one or more thermal values for at least one layer of the object with the hollow portion.

7. The computer-implemented method of claim 1, wherein dispensing, via the secondary nozzle, the first type of particles into the first hollow portion of the object further comprises:
instructing a particle dispersion device with the secondary nozzle to relocate to the first hollow portion of the object;
activating a first control valve for a first particle storage associated with the first type of particles; and
activating a particle control valve on the particle dispersion device, wherein activating the first control valve and the particle control valve dispenses the first type of particles into the first hollow portion of the object.

8. A computer program product comprising:
one or more computer-readable storage media;
program instructions, stored on at least one of the one or more storage media, to identify a solidification pattern for an object with a first hollow portion being created by a primary nozzle on an additive manufacturing device during a hollow fill additive manufacturing process;
program instructions, stored on at least one of the one or more storage media, to generate an additive manufacturing fill plan for the first hollow portion of the object based at least on the solidification pattern;
program instructions, stored on at least one of the one or more storage media, to determine to dispense a first type of particles into the first hollow portion of the object based on the additive manufacturing fill plan; and
program instructions, stored on at least one of the one or more storage media, to dispense, via a secondary nozzle, the first type of particles into the first hollow portion of the object.

9. The computer program product of claim 8, further comprising program instructions, stored on at least one of the one or more storage media, to:
determine a volume of particles to at least partially fill the first hollow portion of the object;
determine the first type out of a plurality of types of particles to at least partially fill the first hollow portion of the object; and
determine a ratio for the first type of particles to at least partially fill the first hollow portion of the object.

10. The computer program product of claim 9, wherein the additive manufacturing fill plan is further based on the first type of particles and the ratio for the first type of particles to at least partially fill the first hollow portion of the object.

11. The computer program product of claim 9, further comprising program instructions, stored on at least one of the one or more storage media, to:
determine a second type out of the plurality of types of particles to at least partially fill the first hollow portion of the object;
determine to dispense a second type of particles into the first hollow portion of the object based on the additive manufacturing fill plan; and
dispense, via the secondary nozzle, the second type of particles into the first hollow portion of the object.

12. The computer program product of claim 11, wherein the additive manufacturing fill plan is further based on the first type of particles, the second type of particles, and the ratio for the first type of particles to at least partially fill the first hollow portion of the object.

13. The computer program product of claim 8, further comprising program instructions, stored on at least one of the one or more storage media, to:
monitor, via one or more scanning modules, the hollow fill additive manufacturing process, wherein monitoring includes receiving one or more thermal values for at least one layer of the object with the hollow portion.

14. The computer program product of claim 8, wherein program instructions, stored on at least one of the one or more storage media, to dispense, via the secondary nozzle, the first type of particles into the first hollow portion of the object further comprises program instructions, stored on at least one of the one or more storage media, to:
instruct a particle dispersion device with the secondary nozzle to relocate to the first hollow portion of the object;
activate a first control valve for a first particle storage associated with the first type of particles; and
activate a particle control valve on the particle dispersion device, wherein activating the first control valve and the particle control valve dispenses the first type of particles into the first hollow portion of the object.

15. A computer system comprising:
one or more processors, one or more computer-readable memories and one or more computer-readable storage media;
program instructions, stored on at least one of the one or more storage media for execution by at least one of the one or more processors via at least one of the one or more memories, to identify a solidification pattern for an object with a first hollow portion being created by a primary nozzle on an additive manufacturing device during a hollow fill additive manufacturing process;
program instructions, stored on at least one of the one or more storage media for execution by at least one of the one or more processors via at least one of the one or more memories, to generate an additive manufacturing fill plan for the first hollow portion of the object based at least on the solidification pattern;
program instructions, stored on at least one of the one or more storage media for execution by at least one of the one or more processors via at least one of the one or more memories, to determine to dispense a first type of particles into the first hollow portion of the object based on the additive manufacturing fill plan; and
program instructions, stored on at least one of the one or more storage media for execution by at least one of the one or more processors via at least one of the one or more memories, to dispense, via a secondary nozzle, the first type of particles into the first hollow portion of the object.

16. The computer system of claim 15, further comprising program instructions, stored on at least one of the one or more storage media for execution by at least one of the one or more processors via at least one of the one or more memories, to:
determine a volume of particles to at least partially fill the first hollow portion of the object;
determine the first type out of a plurality of types of particles to at least partially fill the first hollow portion of the object; and
determine a ratio for the first type of particles to at least partially fill the first hollow portion of the object.

17. The computer system of claim 16, wherein the additive manufacturing fill plan is further based on the first type of particles and the ratio for the first type of particles to at least partially fill the first hollow portion of the object.

18. The computer system of claim 16, further comprising program instructions, stored on at least one of the one or more storage media for execution by at least one of the one or more processors via at least one of the one or more memories, to:
determine a second type out of the plurality of types of particles to at least partially fill the first hollow portion of the object;
determine to dispense a second type of particles into the first hollow portion of the object based on the additive manufacturing fill plan; and
dispense, via the secondary nozzle, the second type of particles into the first hollow portion of the object.

19. The computer system of claim 15, further comprising program instructions, stored on at least one of the one or more storage media for execution by at least one of the one or more processors via at least one of the one or more memories, to:
monitor, via one or more scanning modules, the hollow fill additive manufacturing process, wherein monitoring includes receiving one or more thermal values for at least one layer of the object with the hollow portion.

20. The computer system of claim 15, wherein program instructions, stored on at least one of the one or more storage media for execution by at least one of the one or more processors via at least one of the one or more memories, to dispense, via the secondary nozzle, the first type of particles into the first hollow portion of the object further comprises program instructions, stored on at least one of the one or more storage media for execution by at least one of the one or more processors via at least one of the one or more memories, to:
instruct a particle dispersion device with the secondary nozzle to relocate to the first hollow portion of the object;
activate a first control valve for a first particle storage associated with the first type of particles; and
activate a particle control valve on the particle dispersion device, wherein activating the first control valve and the particle control valve dispenses the first type of particles into the first hollow portion of the object.
